(19) United States
(12) Patent Application Publication
(10) Pub. No.: US 2008/0190410 A1
(43) Pub. Date: Aug. 14, 2008

(54) Charcoal lighting device

(76) Inventors: Joseph Krippelz, Sugar Grove, IL (US); Jacob Krippelz, Oswego, IL (US); Jacob Krippelz, Sugar Grove, IL (US)

Correspondence Address: RYNDAK & SURI LLP, 200 W. MADISON STREET, SUITE 2100, CHICAGO, IL, 60606, US

(21) Appl. No.: 11/706,894

(22) Filed: Feb. 14, 2007

(51) Int. Cl. A47J 37/00

(52) U.S. Cl. 126/25 B

(57) ABSTRACT

A charcoal lighting device is provided that is particularly adapted for lighting a charcoal grill. Methods of lighting a grill are also provided using such devices. The devices and use thereof allows for quick and efficient lighting of a charcoal grill utilizing a non-petroleum based accelerant and therefore not having a significant deleterious effect on the properties of the food.

### FIELD OF THE INVENTION

The present invention relates to a charcoal lighting device adapted to allow for quick and easy lighting of charcoal.

### BACKGROUND OF THE INVENTION

Many individuals enjoy food that is prepared on a charcoal grill. It can be difficult to light the charcoal when preparing to use a charcoal grill. These individuals often douse the charcoal with large amounts of lighter fluid, a petroleum based substance. It also can take a significant amount of time for the charcoal to burn sufficiently to enable cooking on the grill. Moreover, lighter fluid contains potentially harmful carcinogenic agents that may be transferred to the food that is prepared on the grill, negatively affecting the taste and safety of the food.

Many people also enjoy food that is prepared on a charcoal grill that is seasoned or contains added spices. It can be a time consuming process to pre-season the food that is going to be cooked on the grill.

In view of the foregoing, there exists a need for a charcoal lighting device that will quickly ignite charcoal without the use of potentially harmful carcinogenic agents. A need also exists for a charcoal lighting device that will not impart negative flavors to the food prepared on the grill. Additionally, a need also exists for a charcoal lighting device that will impart spices and seasonings to the food prepared on the grill, without requiring the user to pre-season the food. Finally, a need exists to enable cooking on the grill prior to the time the charcoal has sufficiently burned to permit cooking with the charcoal.

### SUMMARY OF THE INVENTION

In accordance with the present invention, a charcoal lighting device and method for use thereof, typically in connection with a charcoal grill, is provided. The charcoal lighting device is particularly useful for quickly lighting charcoal for use on a charcoal grill without adding any undesired flavors or harmful carcinogenic chemicals to the food prepared on the charcoal grill. The appearance, taste, texture and safety of the foods prepared on a grill using the charcoal lighting device are not negatively impacted by using a charcoal lighting device to light the charcoal on a grill. “Charcoal” as used herein includes charcoal briquettes, lump charcoal, other forms of charcoal and wood.

In one aspect of the invention, a charcoal lighting device is provided which is adapted to allow for the quick ignition of charcoal briquettes. The charcoal lighting device includes a porous, oil-absorbent and combustible solid substrate with a non-petroleum based accelerant absorbed into the solid substrate. The body of the charcoal lighting device contains at least one receptacle with a base and sidewalls and configurable in a nestable array. Typically, the charcoal lighting device contains a plurality of receptacles configurable in a nestable array. Any non-petroleum based accelerant can be incorporated into the charcoal lighting device. Typically, the accelerant will be an edible oil, wax, or fat. Examples include organic or inorganic accelerants such as grapeseed oil, olive oil, vegetable oil, sunflower seed oil, peanut oil, palm oil wax, vegetable shortening, or any other types of waxes or oils.

The sidewall structure of the charcoal lighting device can form a charcoal lighting device of any shape as desired. Typically, the individual sidewall structures will be triangular-shaped, forming a charcoal lighting device with a rectangular-shaped base with a top portion being a point at the end opposite the base. The sidewall structures define a volume between the base and the top portion. The overall height of the charcoal lighting device can be any height as desired to effectively surround individual charcoal briquettes. Typically, the charcoal lighting device height will be between 1 and 6 inches high. More typically, the charcoal lighting device height will be between 3 and 5 inches high.

The base of the charcoal lighting device can be any appropriate shape. Typically, the base will be rectangular or oval in shape. More typically, the base will be approximately square in shape. The length of each side of the base can be any suitable length to support the charcoal lighting device. Typically, each side will be between about 1 and 6 inches wide and between about 1 and 6 inches long. More typically, each side will be between about 3 and 5 inches wide and between about 3 and 5 inches long.

The sidewall structures define a volume between the base and the top portion. The volume can be any suitable volume sufficiently large enough to hold at least one charcoal briquette and to allow for sufficient airflow through the charcoal lighting device to ignite both the charcoal lighting device and the charcoal briquettes contained within or surrounding the charcoal lighting device.

In accordance with a further aspect of the invention, flavor enhancers are added to or incorporated within the solid substrate of the charcoal lighting device. Any type of flavor enhancer may be added to the solid substrate, such as spices, seasonings, wood pieces, or wood chips. Typically, flavor enhancers that complement barbequed food are incorporated into the solid substrate. Any type of seasoning or spice may be incorporated into the solid substrate, such as parsley, rosemary, oregano, basil, garlic, garlic cloves, citrus peels, orange peel, lime peel, lemon peel, nutmeg, cinnamon, or cinnamon sticks. Any type of wood or flavored wood can be incorporated into the solid substrate, such as, alder, maple, hickory, oak, birch, apple, cherry, peach, lemon, pear, pecan, mesquite, barbeque-infused, grapevine, alcohol barrel, whiskey barrel, wine barrel, or mesquite-infused wood.

In accordance with another aspect of the invention, at least one of the receptacles of the charcoal lighting device contains at least one aperture. The aperture may be of any suitable shape or size to provide airflow, thereby stimulating the burning of the receptacle and increasing the heat transfer and ignition of the charcoal briquettes. Typically, the aperture is located in the lower portion of the charcoal lighting device. Typically, each of the receptacles contains at least one aperture.

In accordance with another aspect of the invention, the charcoal lighting device also comprises at least one wick. The wick facilitates easy ignition of the charcoal lighting device. The wick can be made of any flammable material. The wick extends through any portion of at least one receptacle in the charcoal lighting device. Typically, the wick extends approximately throughout the height of the individual receptacle, and protrudes from the top portion of the receptacle. Alternatively, the wick may protrude from the side portion or bottom portion of the receptacle. The wick may protrude from multiple portions of the receptacle. The wick may be infused with a non-petroleum based accelerant to allow for quick lighting of the charcoal lighting device.

In accordance with another aspect of the present invention, a method of lighting a grill and cooking is provided. A charcoal lighting device is provided. The charcoal lighting device includes a porous, oil-absorbent and combustible solid substrate with a non-petroleum based accelerant absorbed into the solid substrate. The body of the charcoal lighting device contains at least one receptacle with a base and sidewalls and configurable in a nestable array. Typically, the body of the charcoal lighting device contains a plurality of receptacles configurable in a nestable array. Any non-petroleum based accelerant and preferably a non-toxic to humans accelerant can be incorporated into the charcoal lighting device. Typically, the accelerant will be an edible oil, wax, or fat. Examples of non-toxic accelerants include organic or inorganic accelerants such as grapeseed oil, olive oil, vegetable oil, sunflower seed oil, peanut oil, palm oil wax, vegetable shortening, or any other types of waxes or oils. At least one charcoal briquette is placed around the receptacles. Typically, a plurality of charcoal briquettes are positioned around the receptacles. Typically, the charcoal lighting device is positioned such that the base is at the bottom and the top portion is protruding from the charcoal briquettes surrounding the device. Alternatively, the charcoal lighting device may be positioned such that the base is at the top to allow the receptacle to act as a container capable of holding charcoal briquettes. The combustion of solid substrate is initiated, such as by lighting with a match or other source of a combustion flame. Ignition of the solid substrate ignites the charcoal briquettes and prepares the grill for grilling food.

In accordance with the method, cooking can commence by placing a food item on the grill or other cooking surface when or shortly after combustion of the accelerant is initiated (such as about 30 seconds to about 2, 3 or 4 minutes, for example) or at any time prior to or after combustion of the accelerant begins or is completed. By commencing cooking while the accelerant and/or substrate is burning, cooking can commence much sooner than waiting for the charcoal to generate sufficient combustion heat for cooking. In addition, by cooking food during combustion of the accelerant and/or the solid substrate material including any flavor enhancers that have been added to the substrate, and preferably prior to elimination of the flavor enhancers from the substrate whether by combustion, volatilization or other mechanisms, beneficial and desirable flavors can be imparted to the food on or otherwise associated with the grill.

The sidewall structure of the charcoal lighting device can form a charcoal lighting device of any shape as desired. Typically, the individual sidewall structures will be triangular-shaped, forming a charcoal lighting device with a rectangular-shaped base with a top portion being a point at the end opposite the base. The sidewall structures define a volume between the base and the top portion. The overall height of the charcoal lighting device can be any height as desired to effectively surround individual charcoal briquettes. Typically, the charcoal lighting device height will be between 1 and 6 inches high. More typically, the charcoal lighting device height will be between 3 and 5 inches high.

The base of the charcoal lighting device can be any appropriate shape. Typically, the base will be rectangular or oval in shape. More typically, the base will be approximately square in shape. The length of each side of the base can be any suitable length to support the charcoal lighting device. Typically, each side will be between 1 and 6 inches long. More typically, each side will be between 3 and 5 inches long.

The sidewall structures define a volume between the base and the top portion. The volume can be any suitable volume to hold at least one charcoal briquette and to allow for sufficient airflow through the charcoal lighting device to ignite both the charcoal lighting device and the charcoal briquettes contained within or surrounding the charcoal lighting device.

In accordance with a further aspect of the invention, flavor enhancers are incorporated within the solid substrate of the charcoal lighting device, imparting additional flavoring to the food being grilled. Any type of flavor enhancer may be added to the solid substrate, such as spices, seasonings, alcoholic spirits, wood pieces, or wood chips. Typically, flavor enhancers that complement barbequed food are incorporated into the solid substrate. Any type of seasoning, spice, or alcoholic spirits may be incorporated into the solid substrate, such as parsley, rosemary, oregano, basil, garlic, garlic cloves, citrus peels, orange peel, lime peel, lemon peel, nutmeg, cinnamon, cinnamon sticks, brandy, rums, vodkas, or flavored liqueurs. Any type of wood or flavored wood can be incorporated into the solid substrate, such as, alder, maple, hickory, oak, birch, apple, cherry, peach, lemon, pear, pecan, mesquite, barbeque-infused, grapevine, alcohol barrel, whiskey barrel, wine barrel, or mesquite-infused wood.

In accordance with another aspect of the invention, at least one of the receptacles of the charcoal lighting device contains at least one aperture that causes air to flow throughout the receptacle, thereby increasing the efficiency of lighting the grill. The aperture may be of any suitable shape or size to provide airflow, thereby stimulating the burning of the receptacle and increasing the heat transfer and ignition of the charcoal briquettes. Typically, the aperture is located in the lower portion of the charcoal lighting device. Typically, each of the receptacles contains at least one aperture.

In accordance with another aspect of the invention, the charcoal lighting device also comprises at least one wick that can be ignited to initiate combustion. The wick facilitates easy ignition of the charcoal lighting device. The wick can be made of any suitable flammable material. The wick extends through any portion of at least one receptacle in the charcoal lighting device. Typically, the wick extends through a portion of each receptacle in the charcoal lighting device. Typically, the wick extends approximately throughout the height of the individual receptacle, and protrudes from the top portion of the receptacle. Alternatively, the wick may protrude from the side portion or bottom portion of the receptacle. The wick may protrude from multiple portions of the receptacle. Typically, the wick will extend about 0.5 to 3 inches outside of the receptacle and about 0.5 to 5 inches inside an interior volume of the receptacle. The wick may be infused with a non-petroleum based accelerant to allow for quick lighting of the charcoal lighting device.

In accordance with another aspect of the invention, each receptacle is a pyramidal shape with an aperture at the tip of the pyramid where the sides come together. The aperture can be an opening of any suitable size in order to promote airflow throughout the receptacle. A wick may protrude through each aperture, allowing for easy lighting of the device.

### BRIEF DESCRIPTION OF THE FIGURES

The accompanying drawings form part of the specification and like numerals are employed to designate like parts throughout the same.

FIG. 1 is a perspective view of an embodiment of the charcoal lighting device in accordance with the invention.

FIG. 2 is a perspective view with a cut-away portion of another embodiment of the charcoal lighting device in accordance with the invention.

FIG. 3 is a perspective view of another embodiment of the charcoal lighting device in accordance with the invention.

FIG. 4 is a perspective view of another embodiment of the charcoal lighting device in accordance with the invention.

FIG. 5 is a perspective view of a method of using the charcoal lighting device in accordance with the invention.

FIG. 6 is a perspective view of another embodiment of a method of using the charcoal lighting device in accordance with the invention.

FIG. 7 is a perspective view of another embodiment of the charcoal lighting device in accordance with the invention.

FIG. 8 is a perspective view of another embodiment of the charcoal lighting device in accordance with the invention.

FIG. 9 is a perspective view of another embodiment of the charcoal lighting device in accordance with the invention.

FIG. 10 is a perspective view of a method of using the charcoal lighting device in accordance with the invention.

FIG. 11 is a perspective view of another embodiment of substrate of the charcoal lighting device in accordance with the invention.

### DETAILED DESCRIPTION OF THE INVENTION

While this invention is susceptible of embodiment in many different forms, there is shown in the drawings and described in detail herein, several specific embodiments with the understanding that the present disclosure is to be considered as exemplifications of the principles of the invention and is not intended to limit the invention to the embodiments illustrated.

Referring to the figures generally, and in particular to FIG. 1, a charcoal lighting device 10 according to the present invention is shown generally as having a body 12 comprising a base 14 and sidewalls 16 a-d. Base 14 is rectangularly shaped and sidewalls 16 a-d are triangular. Sidewalls 16 a-d come together in a generally conical form ending at a tip 18 and defining an interior volume 20. Base 14 is typically wider than sidewalls 16 a-d. Charcoal lighting device 10 is configurable in a nestable array.

Body 12 comprises a porous, oil-absorbent, combustible solid substrate. Typically, body 12 is coated with a non-petroleum based accelerant that is absorbed into the solid substrate. Body 12 further comprises wood chips W and spices S integrated throughout the solid substrate.

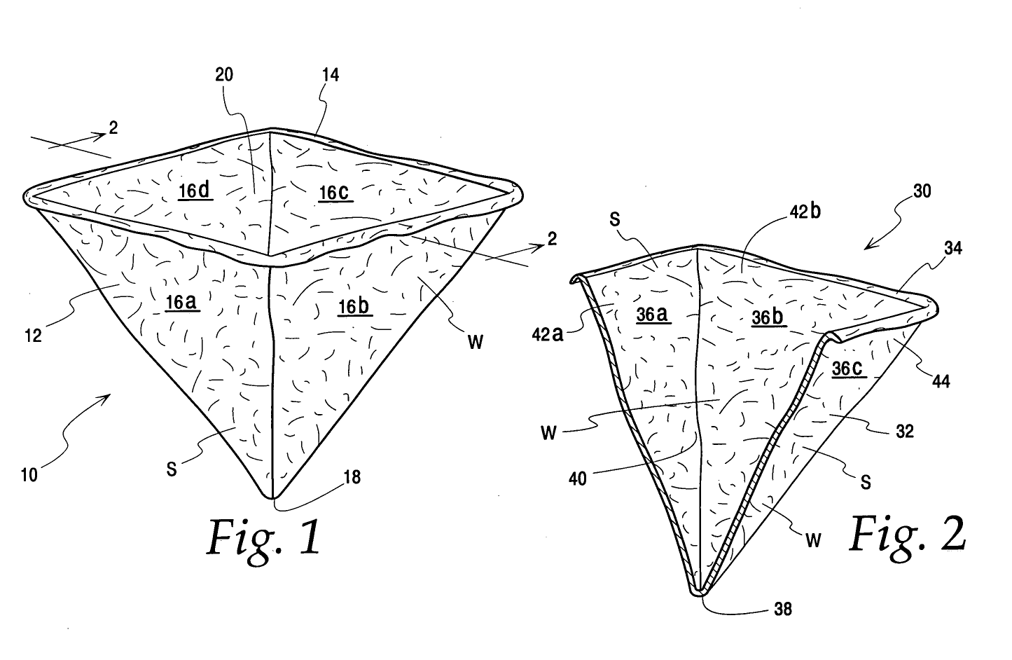

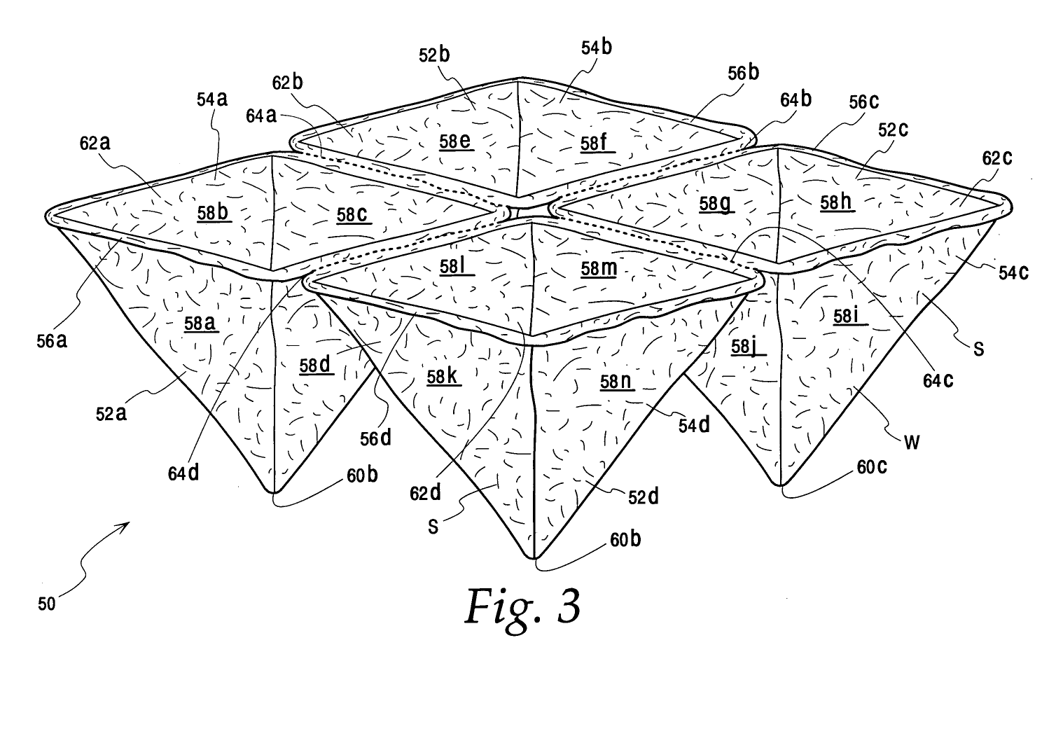

Referring to the figures generally, and in particular to FIG. 2, a cut-away portion of a charcoal lighting device 30 according to the present invention is shown generally as having a body 32 comprising a base 34 and sidewalls 36 a-c. Base 34 is generally rectangularly shaped, a cross section of half of one base is illustrated as base 34. Sidewalls 36 a-c are triangular, coming together in a generally conical form ending at a tip 38 and defining an interior volume 40.

Body 32 is typically a porous, oil-absorbent, combustible solid substrate that is coated with a non-petroleum based accelerant that is absorbed into the solid substrate. Body 32 further comprises wood chips W and spices S, integrated throughout the solid substrate. Wood chips W and spices S are located throughout body 32, comprising part of sidewall interior 42 a-b and sidewall exterior 44.

Sidewalls 36 a-c can be any thickness as desired to achieve proper burning time to ignite charcoal while still allowing for easy lighting and ignition of charcoal lighting device 30. Typically, sidewalls 36 a-c will be less than about 1 centimeter thick. More typically, sidewalls 36 a-c will be less than about 0.5 centimeter thick. Typically, base 34 is less than about 2 centimeters thick. More typically, base 34 is between about 0.75 and 1.25 centimeters thick.

Referring to the figures generally, and in particular to FIG. 3, a charcoal lighting device 50 according to the present invention is shown generally as having four receptacles 52 a-d. Each receptacle 52 a-d has a body 54 a-d comprising a base 56 a-d and sidewalls 58 a-n. Each base 56 a-d is generally rectangularly shaped and sidewalls 58 a-n are triangular, coming together in a generally conical form ending at a tip 60 a-c and defining an interior volume 62 a-d.

Each body 54 a-d is typically a porous, oil-absorbent, combustible solid substrate that is coated with a non-petroleum based accelerant that is absorbed into the solid substrate. Each body 54 a-d further comprises wood chips W and spices S, that can be integrated throughout the solid substrate or, if desired, primarily or exclusively on an interior portion thereof. This could be achieved by applying additional substrate material over a base substrate having the flavor enhancer and in which the additional substrate material is devoid of flavor enhancers or of a particular type of flavor enhancer. In that manner, the flavor enhancer can be encapsulated in the interior regions of the substrate. This can be particularly advantageous when the flavor enhancer is a liquid or has a vapor pressure, and also helps enable application of the flavor enhancer after combustion of exterior portions of the substrate. Wood chips W and spices S are located throughout each body 54 a-d.

Sidewalls 58 a-n can be any thickness as desired to achieve proper burning time to ignite charcoal while still allowing for easy lighting and ignition of charcoal lighting device 50. Typically, sidewalls 58 a-n are less than about 1 centimeter thick. More typically, sidewalls 58 a-n are less than about 0.5 centimeter thick. Typically, each base 56 a-d is less than about 2 centimeters thick. More typically, each base 56 a-d is between about 0.75 and 1.25 centimeters thick.

Receptacles 52 a-d are attached by perforations 64 a-d along bases 56 a-d. Typically, receptacles 52 a-d are arranged and attached in a rectangular-shaped pattern. Perforations 64 a-d can be of any pattern or thickness as necessary to facilitate easily detaching receptacles 52 a-d from one another.

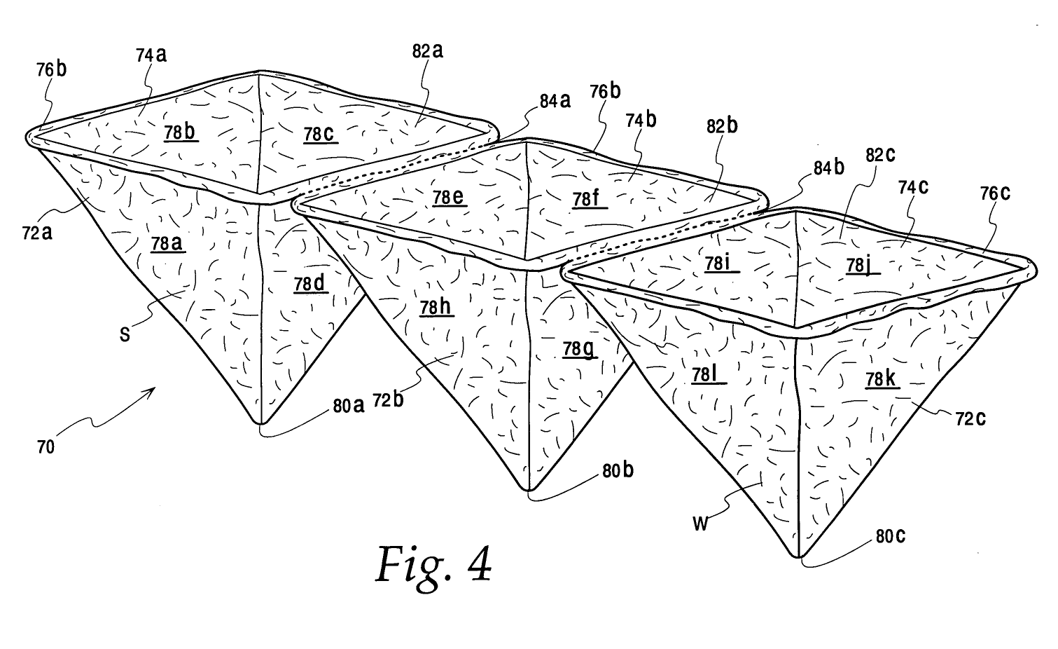

Referring to the figures generally, and in particular to FIG. 4, a charcoal lighting device 70 according to the present invention is shown generally as having three receptacles 72 a-c. Each receptacle 72 a-c has a body 74 a-c comprising a base 76 a-c and sidewalls 78 a-l. Each base 76 a-c is generally rectangularly shaped and sidewalls 78 a-l are triangular, coming together in a generally conical form ending at a tip 80 a-c and defining an interior volume 82 a-c.

Each body 74 a-c is typically a porous, oil-absorbent, combustible solid substrate that is coated with a non-petroleum based accelerant that is absorbed into the solid substrate. Each body 74 a-c further comprises wood chips W and spices S, integrated throughout the solid substrate. Wood chips W and spices S are located throughout each body 74 a-c.

Sidewalls 78 a-l can be any thickness as desired to achieve proper burning time to ignite charcoal while still allowing for easy lighting and ignition of charcoal lighting device 70. Typically, sidewalls 78 a-l are less than about 1 centimeter thick. More typically, sidewalls 78 a-l are less than about 0.5 centimeter thick. Typically, each base 76 a-c is less than about 2 centimeters thick. More typically, each base 76 a-c is between about 0.75 and 1.25 centimeters thick.

Receptacles 72 a-c are attached by perforations 84 a-b along bases 76 a-c. Receptacles 72 a-c are arranged and attached in a linear array. Perforations 84 a-b can be of any pattern or thickness as necessary to facilitate easily detaching receptacles 72 a-c from one another.

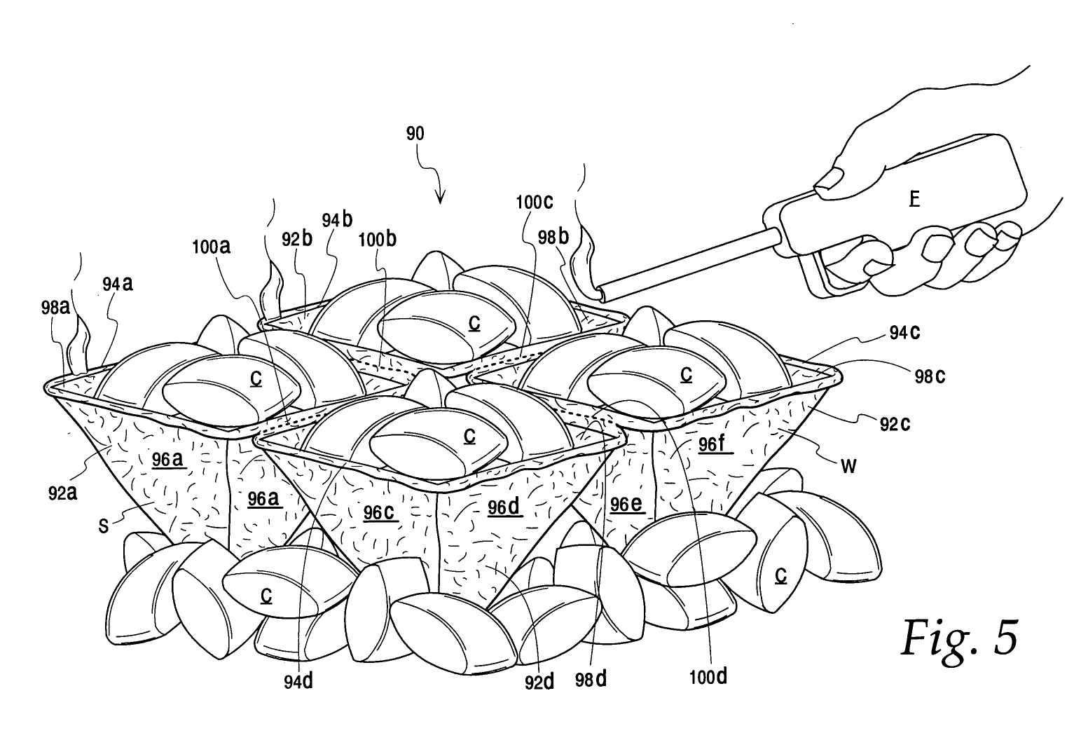

Referring to FIG. 5, a method of lighting a charcoal grill according to the present invention is provided. A charcoal lighting device 90 is provided having four receptacles 92 a-d. Each receptacle 92 a-d comprises a base 94 a-d and sidewalls 96 a-f. Each base 94 a-d is generally rectangularly shaped and sidewalls 96 a-f are generally triangular, coming together in a generally conical form ending at a tip (not shown) and defining an interior volume 98 a-d. Receptacles 92 a-d are typically porous, oil-absorbent, combustible solid substrates that are coated with a non-petroleum based accelerant that is absorbed into the solid substrate. Receptacles 92 a-d further comprise wood chips W and spices S, integrated throughout the solid substrate. Wood chips W and spices S are located throughout receptacles 92 a-d.

Sidewalls 96 a-f can be any thickness as desired to achieve proper burning time to ignite charcoal while still allowing for easy lighting and ignition of charcoal lighting device 90. Typically, sidewalls 96 a-f are less than about 1 centimeter thick. More typically, sidewalls 96 a-f are less than about 0.5 centimeter thick. Typically, each base 94 a-d is less than about 2 centimeters thick. More typically, each base 94 a-d is between about 0.75 and 1.25 centimeters thick. Receptacles 92 a-d are attached by perforations 100 a-d along base 94 a-d. Receptacles 92 a-d are arranged and attached in a generally rectangular shape. Perforations 100 a-d can be of any pattern or thickness as necessary to facilitate easily detaching receptacles 92 a-d from one another.

Several charcoal briquettes C are placed around the tips of receptacles 92 a-d of charcoal lighting device 90 and inside interior volume 98 a-d. Charcoal briquettes C hold charcoal lighting device 90 in place. Using a fire source F, charcoal lighting device 90 is lit on fire in a plurality of locations along bases 94 a-d. Any fire source may be used, such as a lighter or a match. Receptacles 92 a-d will burn and ignite charcoal briquettes C for grilling.

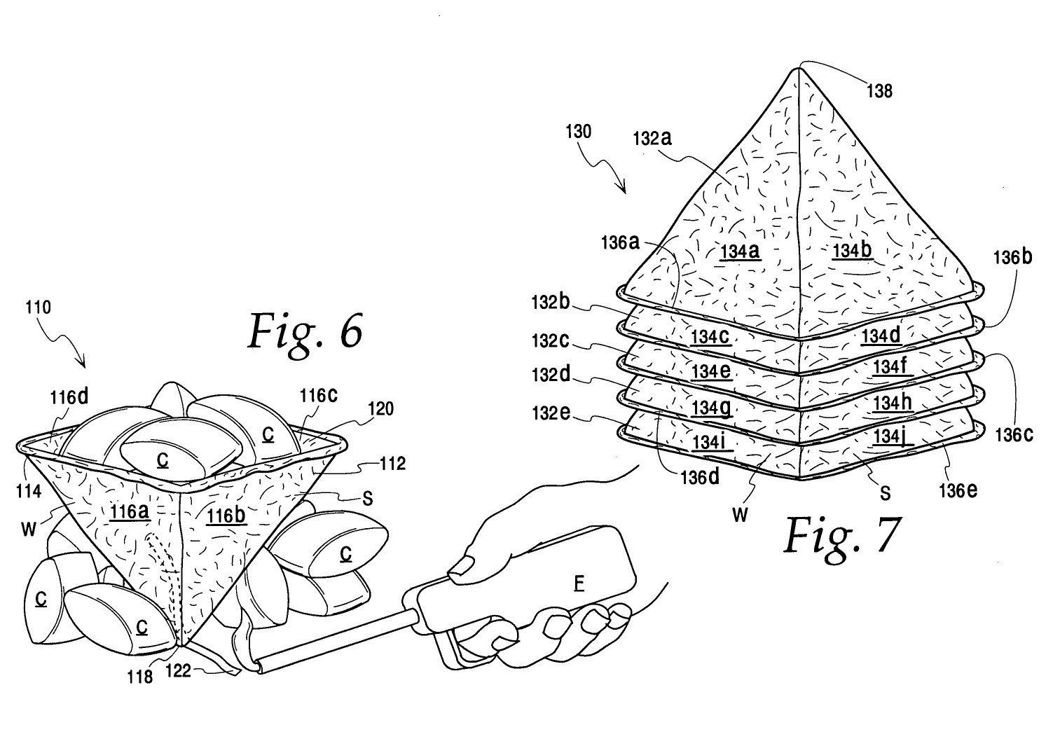

Referring to FIG. 6, a method of lighting a charcoal grill according to the present invention is provided. A charcoal lighting device 110 is provided having a body 112 comprising a base 114 and sidewalls 116 a-d. Base 114 is generally rectangularly shaped and sidewalls 116 a-d are generally triangular, coming together in a generally conical form ending at a tip 118 and defining an interior volume 120. Charcoal lighting device 110 further comprises a wick 122 to assist in lighting charcoal lighting device 110. Wick 122 can be made of any flammable material and may be coated in a non-petroleum based accelerant. Wick 122 protrudes outside of body 112 and throughout interior volume 120. Body 112 is typically a porous, oil-absorbent, combustible solid substrate that is coated with a non-petroleum based accelerant that is absorbed into the solid substrate. Body 112 further comprises wood chips W and spices S, integrated throughout the solid substrate. Wood chips W and spices S are located throughout body 112.

Sidewalls 116 a-d can be any thickness as desired to achieve proper burning time to ignite charcoal while still allowing for easy lighting and ignition of charcoal lighting device 110. Typically, sidewalls 116 a-d are less than about 1 centimeter thick. More typically, sidewalls 116 a-d are less than about 0.5 centimeter thick. Typically, base 114 is less than about 2 centimeters thick. More typically, base 114 is between about 0.75 and 1.25 centimeters thick.

Several charcoal briquettes C are placed around the tip of body 112 of charcoal lighting device 110 and inside interior volume 120. Charcoal briquettes C hold charcoal lighting device 110 in place. Using a fire source F, wick 122 is ignited. Any fire source may be used, such as a lighter or a match. Wick 122 will burn and ignite body 112. Body 112 will burn and ignite charcoal briquettes C for grilling.

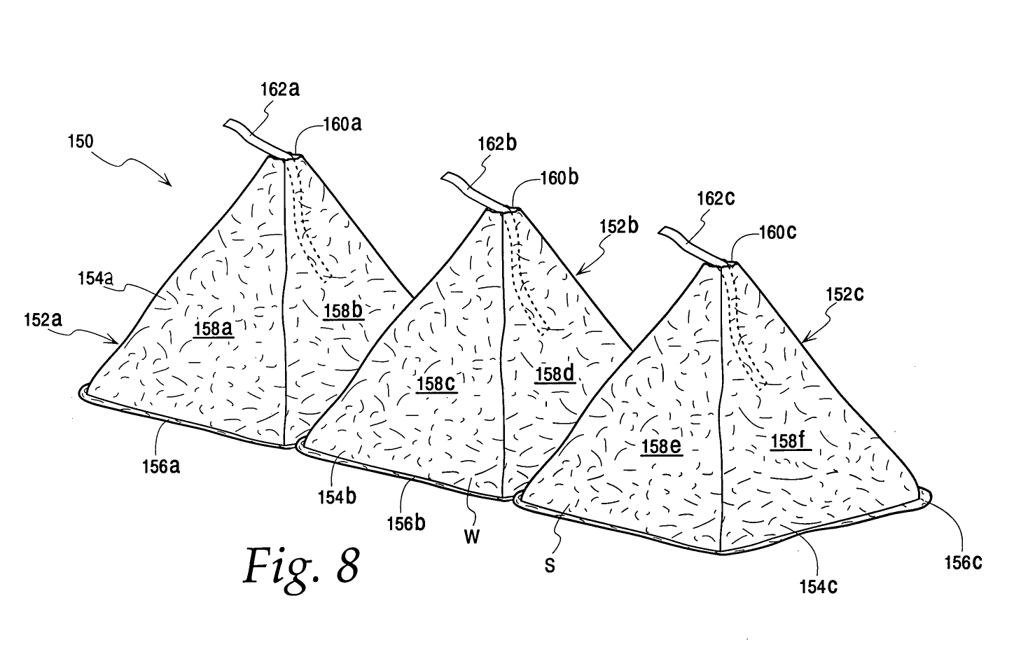

Referring to FIG. 7, a nested stack of charcoal lighting devices 130 is provided. Receptacles 132 a-e are shown configured in nested stack 130. Receptacles 132 a-e each have triangular shaped sidewalls 134 a-j and a base 136 a-e. Receptacles 132 a-e are generally conical in shape, with sidewalls 134 a-j coming to form a tip 138. Nested stack 130 is configured to rest on base 136 e which is approximately flat and planar and can be rested on a table, grill, in packaging, or on another surface.

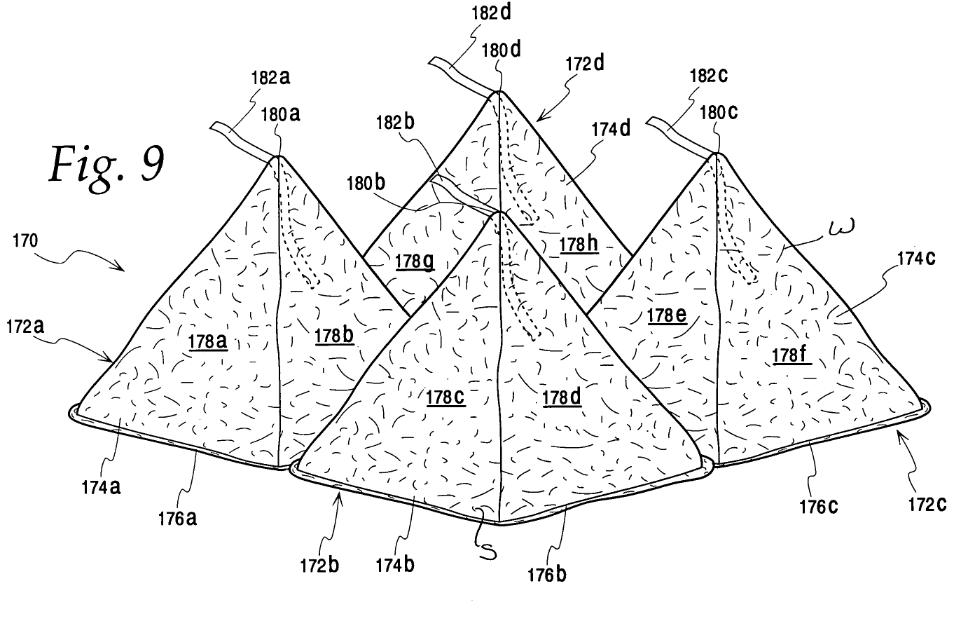

Referring to the figures generally, and in particular to FIG. 8, a charcoal lighting device 150 according to the present invention is shown generally as having three receptacles 152 a-c. Each receptacle 152 a-c has a body 154 a-c comprising a base 156 a-c and sidewalls 158 a-f. Each base 156 a-c is generally rectangularly shaped and sidewalls 158 a-f are triangular, coming together in a generally conical form ending at an aperture 160 a-c. Charcoal lighting device 150 further comprises wicks 162 a-c to assist in lighting charcoal lighting device 150. Wicks 162 a-c can be made of any flammable material and may be coated in a non-petroleum based accelerant. Wicks 162 a-c protrude from apertures 160 a-c outside of receptacles 152 a-c and extend throughout the interior volume of receptacles 152 a-c.

Each body 154 a-c is typically a porous, oil-absorbent, combustible solid substrate that is coated with a non-petroleum based accelerant that is absorbed into the solid substrate. Each body 154 a-c further comprises wood chips W and spices S, integrated throughout the solid substrate. Wood chips W and spices S are located throughout each body 154 a-c.

Sidewalls 158 a-f can be any thickness as desired to achieve proper burning time to ignite charcoal while still allowing for easy lighting and ignition of charcoal lighting device 150. Typically, sidewalls 158 a-f are less than about 1 centimeter thick. More typically, sidewalls 158 a-f are less than about 0.5 centimeter thick. Typically, each base 156 a-c is less than about 2 centimeters thick. More typically, each base 156 a-c is between about 0.75 and 1.25 centimeters thick.

Receptacles 152 a-c are arranged and attached to each other in a linear array. Charcoal lighting device 150 is configured to be supported on bases 156 a-c, which is approximately flat and planar and can be rested on a table, grill, in packaging, or on another surface. Charcoal lighting device 150 is arranged in a nestable linear array, such that additional charcoal lighting devices could be stacked on top of charcoal lighting device 150 to form a nested array of charcoal lighting devices.

Referring to the figures generally, and in particular to FIG. 9, a charcoal lighting device 170 according to the present invention is shown generally as having four receptacles 172 a-d. Each receptacle 172 a-d has a body 174 a-d comprising a base 176 a-c and sidewalls 178 a-h. Each base 176 a-c is generally rectangularly shaped and sidewalls 178 a-h are triangular, coming together in a generally conical form ending at a tip 180 a-d. Charcoal lighting device 170 further comprises wicks 182 a-d to assist in lighting charcoal lighting device 170. Wicks 182 a-d can be made of any flammable material and may be coated in a non-petroleum based accelerant. Wicks 182 a-d protrude through tips 180 a-d and into an interior volume of receptacles 172 a-d. Wicks 182 a-d may be any length suitable to provide contact between a flame and receptacles 172 a-d once wicks 182 a-d are ignited. Typically, wicks 182 a-d will extend about 0.5 to 3 inches outside of receptacles 172 a-d and about 0.5 to 5 inches inside an interior volume of receptacles 172 a-d.

Each body 174 a-d is typically a porous, oil-absorbent, combustible solid substrate that is coated with a non-petroleum based accelerant that is absorbed into the solid substrate. Each body 174 a-d further comprises wood chips W and spices S, integrated throughout the solid substrate. Wood chips W and spices S are located throughout each body 174 a-d.

Sidewalls 178 a-h can be any thickness as desired to achieve proper burning time to ignite charcoal while still allowing for easy lighting and ignition of charcoal lighting device 170. Typically, sidewalls 178 a-h are less than about 1 centimeter thick. More typically, sidewalls 178 a-h are less than about 0.5 centimeter thick. Typically, each base 176 a-c is less than about 2 centimeters thick. More typically, each base 176 a-c is between about 0.75 and 1.25 centimeters thick.

Receptacles 172 a-d are arranged and attached to each other in a rectangular arrangement. Charcoal lighting device 170 is configured to be supported on bases 176 a-c, which is approximately flat and planar and can be rested on a table, grill, in packaging, or on another surface. Charcoal lighting device 170 is arranged in a nestable array, such that additional charcoal lighting devices could be stacked on top of charcoal lighting device 170 to form a nested array of charcoal lighting devices.

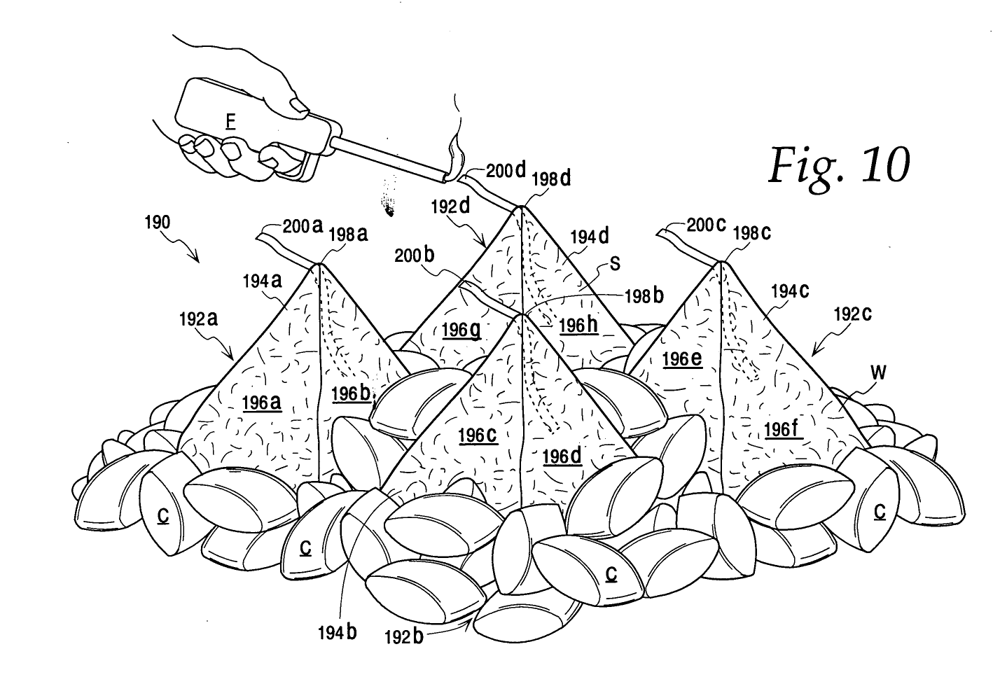

Referring to FIG. 10, a method of lighting a charcoal grill is provided. A charcoal lighting device 190 is provided. Charcoal lighting device 190 comprises receptacles 192 a-d each having a body 194 a-d and sidewalls 196 a-h. Receptacles 192 a-d further comprise a base, not illustrated in FIG. 10. Sidewalls 196 a-h are generally triangular, coming together in a generally conical form ending at tips 198 a-d. Charcoal lighting device 190 further comprises wicks 200 a-d to assist in lighting charcoal lighting device 190. Wicks 200 a-d can be made of any flammable material and may be coated in a non-petroleum based accelerant. Wicks 200 a-d protrude through tips 198 a-d and into an interior volume of receptacles 192 a-d. Wicks 200 a-d may be any length suitable to provide contact between a flame and receptacles 192 a-d once wicks 200 a-d are ignited. Typically, wicks 200 a-d will extend about 0.5 to 3 inches outside of receptacles 192 a-d and about 0.5 to 5 inches inside an interior volume of receptacles 192 a-d.

Each body 194 a-d is typically a porous, oil-absorbent, combustible solid substrate that is coated with a non-petroleum based accelerant that is absorbed into the solid substrate. Each body 194 a-d further comprises wood chips W and spices S, integrated throughout the solid substrate. Wood chips W and spices S are dispersed throughout each body 194 a-d or as otherwise desired. Sidewalls 196 a-h can be any thickness as desired to achieve proper burning time to ignite charcoal while still allowing for easy lighting and ignition of charcoal lighting device 190. Typically, sidewalls 196 a-h are less than about 1 centimeter thick. More typically, sidewalls 196 a-h are less than about 0.5 centimeter thick. Receptacles 192 a-d are arranged and attached to each other in a generally rectangular arrangement. Charcoal lighting device 190 is configured to be supported on a base which is approximately flat and planar and can be rested on a table, grill, in packaging, or on another surface. Charcoal lighting device 190 is arranged in a nestable arrangement, such that additional charcoal lighting devices could be stacked on top of charcoal lighting device 190 to form a nested array of charcoal lighting devices.

Several charcoal briquettes C are placed around the base of receptacles 192 a-d and around each body 194 a-d of charcoal lighting device 190. Charcoal briquettes may be placed in the form of a mound that covers or substantially covers each body 194 a-d of charcoal lighting device 190. Using a fire source F, wicks 200 a-d are lit on fire. Any fire source may be used, such as a lighter or a match. Wicks 200 a-d will burn and ignite receptacles 192 a-d. Receptacles 192 a-d will burn and ignite charcoal briquettes C for grilling.

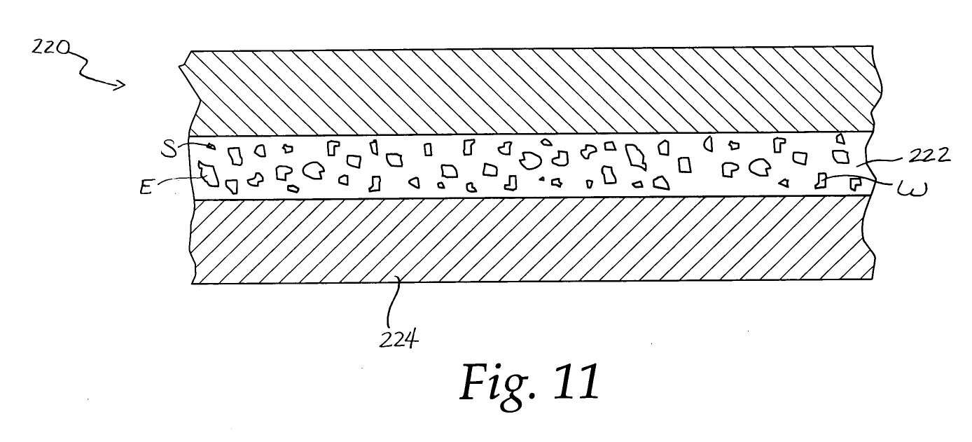

Referring to FIG. 11, a substrate 220 is provided. Substrate 220 comprises a base substrate 222 and additional substrate 224. Base substrate 222 comprises a flavor enhancer E. Flavor enhancer E can comprise wood chips W and spices S. Additional substrate 224 is typically devoid of flavor enhancer E.

While the invention has been described with respect to certain preferred embodiments, as will be appreciated by those skilled in the art, it is to be understood that the invention is capable of numerous changes, modifications and rearrangements, and such changes, modifications and rearrangements are intended to be covered by the following claims.

What is claimed is:

1. A charcoal lighting device comprising:
a porous oil-absorbent combustible solid substrate, a non-petroleum based accelerant absorbed into the solid substrate, at least one receptacle having a base and sidewalls defining a volume and configurable in a nestable array.

2. The charcoal lighting device of claim 1 wherein the at least one receptacle further comprises at least one aperture located in a lower portion of the receptacle.

3. The charcoal lighting device of claim 1 further comprising wood chips integrated throughout said solid substrate.

4. The charcoal lighting device of claim 3 wherein said wood chips are mesquite flavored.

5. The charcoal lighting device of claim 3 wherein said wood chips are hickory.

6. The charcoal lighting device of claim 1 further comprising spices integrated throughout said solid substrate.

7. The charcoal lighting device of claim 1 wherein said non-petroleum based accelerant is grapeseed oil.

8. The charcoal lighting device of claim 1 wherein said non-petroleum based accelerant is olive oil.

9. The charcoal lighting device of claim 1 wherein the at least one receptacle is oval in shape.

10. The charcoal lighting device of claim 1 wherein the at least one receptacle is rectangular in shape.

11. The charcoal lighting device of claim 1 wherein the base of the at least one receptacle is between about 3 inches and 5 inches wide and between about 3 inches and 5 inches long.

12. The charcoal lighting device of claim 1 wherein the volume of the at least one receptacle is sufficiently large enough to contain a charcoal briquette.

13. The charcoal lighting device of claim 1 wherein the height of the sidewalls of the at least one receptacle are between about 3 inches and 5 inches.

14. The charcoal lighting device of claim 1 further comprising at least one wick.

15. A method of lighting a grill comprising:
providing a charcoal lighting device comprising a porous oil-absorbent combustible solid substrate, a non-petroleum based accelerant absorbed into the solid substrate, and at least one receptacle having a base and sidewalls defining a volume and wherein said charcoal lighting device is configurable in a nestable array;
placing at least one charcoal briquette in contact with at least one of said receptacles; and
lighting said solid substrate on fire.

16. The method of claim 15 wherein each receptacle further comprises at least one aperture.

17. The method of claim 15 wherein at least one receptacle further comprises at least one aperture.

18. The method of claim 15 further comprising placing at least one charcoal briquette into each receptacle.

19. The method of claim 15 further comprising associating food in a cooking position with respect to the substrate after said lighting of the substrate.

20. The method of claim 19 wherein said substrate has a flavor enhancer contained therein, further comprising imparting the flavor enhancer to the food.
